(19) United States
(12) Patent Application Publication
(10) Pub. No.: US 2004/0079295 A1
(43) Pub. Date: Apr. 29, 2004

(54) Bird's nesting box

(76) Inventor: Queen Annette Sims, Fremont, OH (US)

Correspondence Address: Queen Annette Sims, 835 Crockett Pl., Memphis, TN, 38107, US

(21) Appl. No.: 10/265,003

(22) Filed: Apr. 10, 2003

Related U.S. Application Data
(60) Provisional application No. 60/350,102, filed on Oct. 20, 2001.

(51) Int. Cl. A01K 31/14

(52) U.S. Cl. 119/329

(57) ABSTRACT

The Bird Nesting Box is one of the most innovative products of its kind. It allows clear visibility of the bird's, their eggs, and young while permitting the owner or caregiver to view and monitor the nesting process without disturbing the birds. This can be exciting and also very educational. This improved design is constructed of durable plexiglas versus the standard wooden nesting box. It is very easy to maintain and inexpensive.

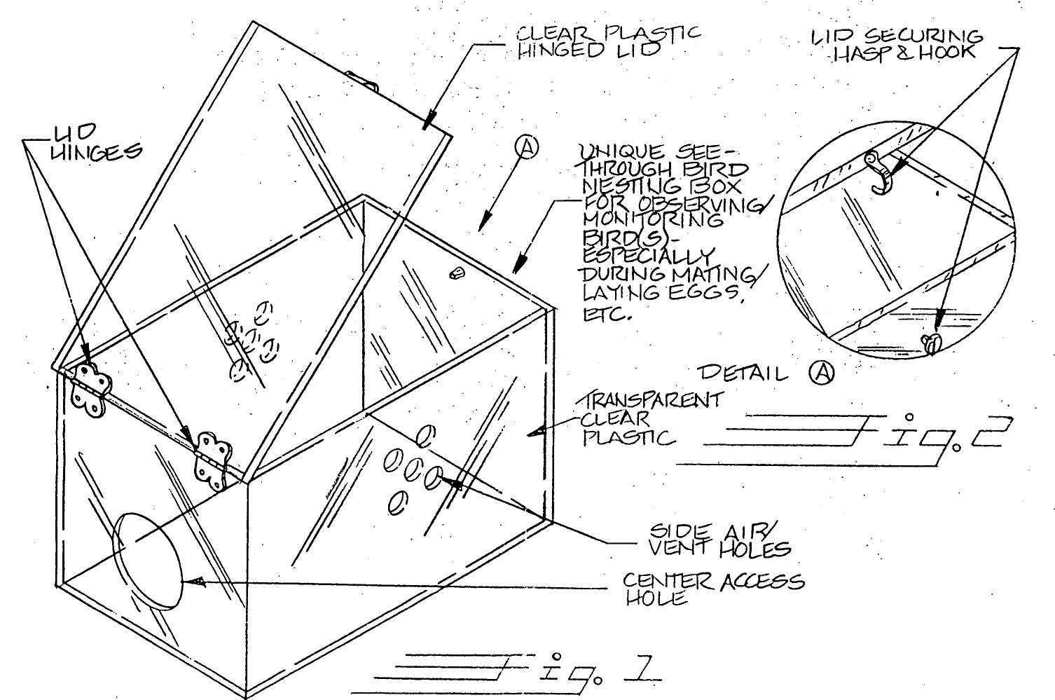

To facilitate one's comprehension and understanding of a new product, that idea must be described not only as it exists as an answer to a subsistent problem, but also as it functions physically. Incorporated into this overview is a description of the invention's physical appearance.

Based upon my description and my outside research, I will describe the basic overall features, shape and design of Bird Nesting Box. Materials of which the invention would be produced will also be described.

The design of Bird Nesting Box calls for plastic, plexiglass and metal to be used as its major components.

A large, rectangular nesting box with rounded comers (optional) would be produced from one-fourth inch thick panels of a transparent acrylic plastic or clear plexiglass held together with corrosion-resistant, two and a half-inch metal screws. The nesting box would measure nine inches in overall length, seven inches in overall width and seven inches in overall height. Other sizes could also be made available to suit birds of different sizes.

The nesting box would have a rectangular lid, two brass or copper butterfly-shaped hinges measuring three-fourths of an inch in length and five inches in width, transparent caulking and a brass/copper hasp and hook to hold the lid shut. Other features of Bird Nesting Box would include 10 small air holes measuring about one-tenth of an inch in diameter and an entrance hole measuring three inches in diameter. The air holes would be divided into two equal sets and would be situated on opposing sides of the nesting box.

The hard plastic components of Bird Nesting Box could be formed with the use of injection molding or blow molding. Injection molding is a process that has been in use since the 1920s and provides a versatility almost unmatched in the mass production of any material. It requires that melted plastic be forcefully injected into relatively cool molds. As the plastic begins to harden, it takes on the shape of the mold cavity and, when cool, requires few postmolding operations. Other advantages of this process include its speed of production and the ability to simultaneously manufacture multiple parts.

Blow molding in the production of plastic shapes is a form of extrusion, a major technique in the plastics industry. Extrusion is used to push a molten tube, called a parison, into a bottle-shaped mold. Compressed air then forces the parison against the cold walls of the mold, hence the term “blow molding”. Molds are generally side fed, with the thickness controlled by a tapered mandrel (core) or a variable-orifice die. Continuous extrusion of the plastic is possible through the use of multiple blow molds.

Bird Nesting Box could also be produced in a second version which would resemble a bird house with a peaked roof. This version would be produced from the same materials as the original version and would have features such as bar magnets to hold the lid in place, a J-shaped hook attached to the side or rear of the box to hold Bird Nesting Box in place, a one-quarter inch metal screw for the hook and a lid with two hinges.

To use Bird Nesting Box, one would place Bird Nesting Box inside a bird cage and allow the bird to become accustomed to its presence. When the bird laid eggs inside the nesting box, the owner would be able to see the eggs and could then monitor the eggs during incubation and hatching without disturbing the birds.

### PROPOSED MODIFICATIONS

In order to fully appreciate the benefits and need of an innovation, one should consider any possible modifications that would arise from the use of the idea.

I, therefore, shall suggest other applications of Bird Nesting Box that would merit future consideration and study. The scope of this review may include the use of materials other than those specified by me. In addition, this review may support the use of additional materials, color schemes, diversified applications, broader consumer outlets or other possible shape and design alterations that may enhance the utility and salability of the invention. All in all, I shall attempt to identify any variations that would further define the scope of the idea.

One must remember, however, that these modification suggestions are limited within the latitude of the invention. Some inventions lend themselves easily to future applications, i.e. different shapes, materials, color schemes, etc. Other inventions, however, are geared to a specific group of consumers, to one particular design or to a strict manufacturing process. As a result, any suggested modifications to the invention may be limited within the invention's scope.

The following modifications are suggested to augment the usefulness and popularity of Bird Nesting Box. It should be noted that these and/or other suggested modifications or variations of my invention will not be included in my preliminary patent art.

In addition to the acrylic plastic suggested by me, Bird Nesting Box could also be created from PVC plastic. This type of plastic would be suitable for use with Bird Nesting Box, since it would be durable, strong, lightweight and relatively inexpensive to use.

The metal screws of Bird Nesting Box could be produced from Type 303 or 304 stainless steel. Common physical characteristics of these metals would be good corrosion resistance and high tensile strength.

I also suggests that Bird Nesting Box could be transported from one location to another by adding a perch and a strap. The strap could be woven from nylon and could have a PVC plastic sliding buckle so that the strap's overall length could be adjusted to suit the preferences of the bird owner. I propose that Bird Nesting Box could be produced using a wood and plastic construction. The wood could be produced from pine, ash or hickory, for durability.

I also suggest that Bird Nesting Box could be accompanied by decals printed in different colors such as white, black, blue and red or by decals printed with decorations such as a house, trees, flowers, animals and other birds. The decals could be made from polyethylene or acrylic plastic film and coated with a transparent glue on the rear side so that they could adhere to the nesting box. The glue coating could be protected by a peel-away strip of paper.

In addition, detailed diagrams and technical specifications remain to be created. Nonetheless, there is a clear idea of my intent and goals in submitting this design.

Overall, the basic concept behind Bird Nesting Box appears to be sound and the product idea is workable. The basic materials are readily available and the concept of a convenient, transparent nesting box that would allow a bird owner to monitor a bird's eggs more easily would appear to appeal to a vast variety of people. The design features in Bird Nesting Box seem well within the limits of present-day technology.

Given the previous description of how the invention would function and taking into consideration the questions facing further development of Bird Nesting Box, it is my tentative judgment that the idea is based on sound principles and that a production version of this item could be developed to perform generally as the Inventor states.

Potential problems that might arise during the development of Bird Nesting Box should be amenable to resolution through normal product testing and refinement processes, after which I would anticipate the product could be produced routinely. However, I also recommend that an interested company should be allowed to do their own form of testing and marketing and to provide modification suggestions.

1. What I claim as my invention is the Bird Nesting Box. I Queen A. Sims claim the Bird Nesting Box as my invention along with all mentioned descriptions, materials, research, and utilization or processing of materials.
